(19) United States
(12) Patent Application Publication
(10) Pub. No.: US 2026/0093311 A1
(43) Pub. Date: Apr. 2, 2026

(54) CONTROL OF LANE-TO-LANE POWER STATE TRANSITIONS

(71) Applicant: Intel Corporation, Santa Clara, CA (US)

(72) Inventors: Nazar Syed HAIDER, Fremont, CA (US); Daniel Mauricio GARCIA MORA, Chandler, AZ (US); Derrick S. ANANG, Phoenix, AZ (US)

(21) Appl. No.: 19/413,856

(22) Filed: Dec. 9, 2025

(51) Int. Cl. G06F 1/3234; G06F 13/42

(52) U.S. Cl. CPC G06F 1/3278; G06F 13/4282; G06F 2213/0026

(57) ABSTRACT

Examples described herein relate to an interface and first circuitry to, based on a configuration: for a power state transition, apply one of multiple sets of lane-to-lane stagger times associated with different respective power state transitions. In some examples, the configuration is to set port-to-port stagger times between multiple power saving states and an active power state. In some examples, the second circuitry is to, based on the configuration, apply lane-to-lane stagger times for a second port between multiple power saving states and an active power state.

In host computing systems, capability to process data at higher rates can involve reducing a latency of data transfer to processors. Peripheral Component Interconnect express (PCIe) specifications define manners of transferring data through lanes of a port. Increasing a number of lanes increase bandwidth and volume of data that can be transferred to a processor.

### BRIEF DESCRIPTION OF THE DRAWINGS

FIGS. 1A and 1B depict example systems.

FIG. 2 depicts examples of calculating delay or stagger values.

FIGS. 3A and 3B depict examples of utilization of distinct stagger values.

FIG. 4 shows an example of power delivery noise improvement.

FIGS. 5A and 5B depict examples of configured timing delay between transitions to an active power state from port-to-port.

FIG. 6 depicts an example process.

FIG. 7 depicts an example system.

### DETAILED DESCRIPTION

To enable signal transfer over lanes, PCIe specifications set forth electrical specifications for the power delivery distribution to PCIe ports. As an example, PCI Express 6.0 Specification (2022) design limits power supply noise for multiple frequency bands to tens of millivolts (mV). Violations of these noise voltages result in reduced margins and even complete functional failures.

When utilized bandwidth across lanes and ports decreases, reducing power states of lanes and ports can reduce power consumption and reduce costs of utilizing the ports. Some host systems supply multiple power states to PCIe Generation 6 consistent ports: L1, L0p, and L0, where L1 is the deepest and lowest power state, L0p is an intermediate power saving state while L0 is the active power state.

When there is a transition between power states, the change in current over time (di/dt), or the current step can cause a noise on the power supply network. In other words, power state transitions for N ports results in di/dt multiplied by N and a corresponding additive increase in noise on the power supply network. A simultaneous exit from a low power state to a higher power state (e.g., L1 to L0) results in an undershoot of voltage while the opposite change (e.g., L0 to L1) results in an overshoot. Meeting power supply noise specifications for high speed IOs like PCIe is becoming increasingly challenging due to higher speeds and increase of the lane counts in each generation of host systems.

Various examples can control lane-to-lane and port-to-port transitions from L1 or L0p to L0 and from L0 to L1 or L0p to potentially reduce power supply noise and improve margin to power delivery specifications at least for communications consistent with PCIe Generation 6. Controlling lane-to-lane and port-to-port stagger times can reduce cost and area on both package and die. Because the noise on the power supply can be impacted by physical proximity of ports on a die, different ports on the die can have a custom setting for lane-to-lane and port-to-port stagger to improve margins.

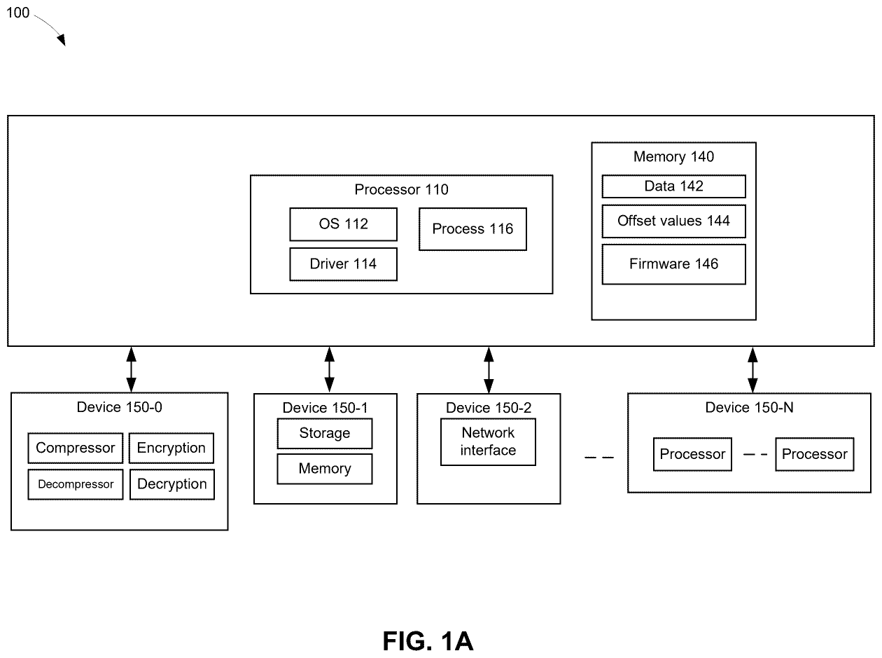

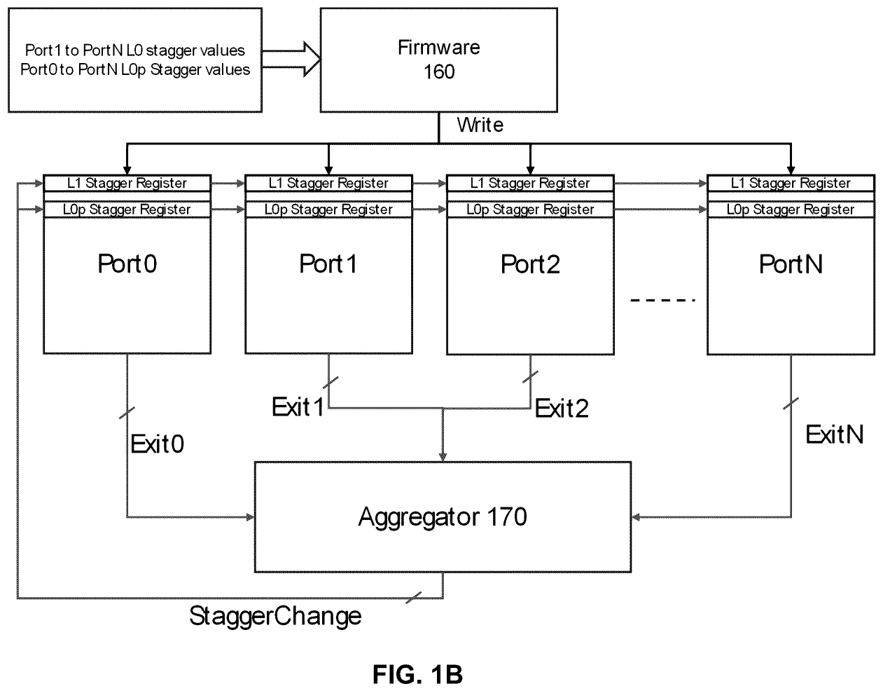

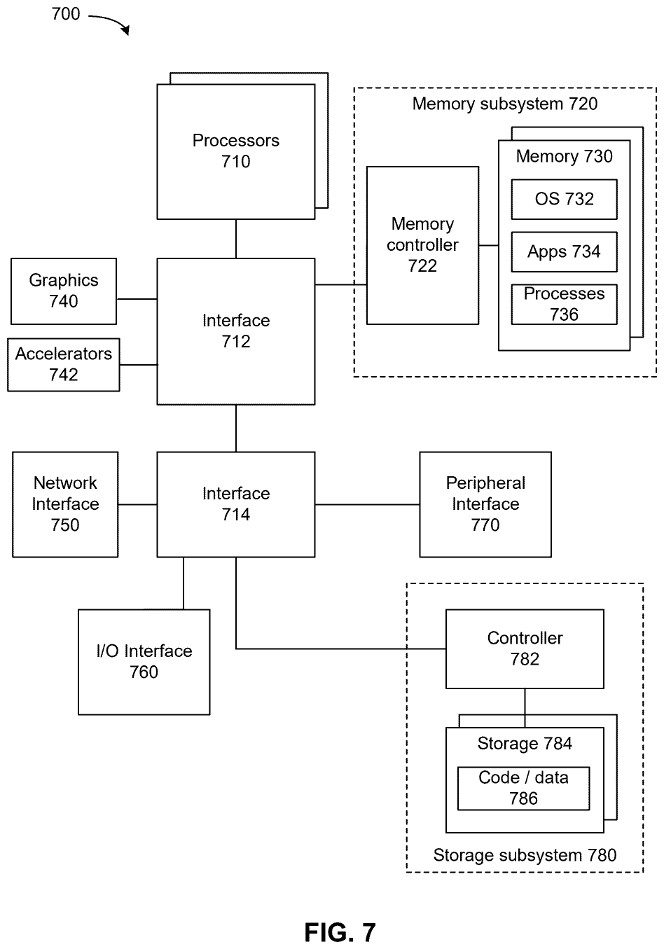

FIG. 1A depicts an example system. System 100 can include processor 110, memory 130, one or more of devices 150-0 to 150-N, where Nis an integer, and other circuitry and software described at least with respect to FIG. 7. In some examples, system 100 can be implemented in a semiconductor package. The semiconductor package can include metal, plastic, glass, and/or ceramic casing that covers and encapsulates one or more semiconductor devices or integrated circuits (e.g., processor 110, memory 140, or one or more of devices 150-0 to 150-N) and provides communications within or among the one or more semiconductor devices or integrated circuits.

Processor 110 can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Accelerator cores, slices, and/or cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processor 110 can execute processes 116 that can request packet processing, packet transmission, copying of received packets, data compression, data decompression, data encryption, data decryption, data copying, or other operations to be performed by one or more of devices 150-0 to 150-N. Processes 116 can include one or more of: an application, process, thread, a virtual machine (VM), microVM, container, microservice, virtual function (VF), virtual device, or other virtualized execution environment.

One or more of devices 150-0 to 150-N can include one or more: accelerator, graphics processing unit (GPU), storage device, network interface device, or other circuitry. For example, an accelerator can perform cryptographic, compression, or decompression operations on data.

Processor 110 can access one or more of devices 150-0 to 150-N by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 110, memory 140, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits.

Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

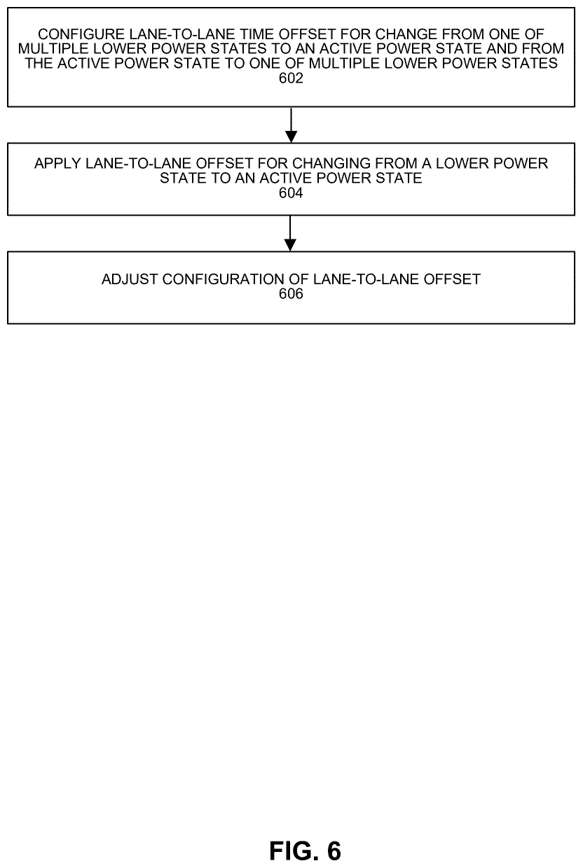

One or more of devices 150-0 to 150-N can perform operations offloaded from processor 110. Devices 150-0 to 150-N can include one or more of: an accelerator, a memory device, a memory controller, a storage device, a storage controller, a network interface device, or other circuitry, such as circuitry described with respect to FIGS. 6 and/or 7. A network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

Firmware 146 can program, into memory 140, offset values 144 from multiple reduced power states to an active power state or the active power state to multiple reduced power states for individual lanes to provide lane-to-lane time delay or stagger. A lane can represent a conductive medium of a port that serially transmits bits unidirectionally, a conductive medium of a bus that serially transmits bits unidirectionally, or a conductive medium that serially transmits bits unidirectionally (e.g., copper wire or other conductive medium). Offset values can be specified for different lanes of different ports. At boot or reset, firmware 146 can read per-lane stagger values 144 from registers in memory 140 and apply the timing offset, as described herein, prior to transition to the active state or from the active state to one of the multiple reduced power states. Stagger values can be programmable and can be modified and tuned based on power state exit latency requirements and system level transmission margins during transmissions. Customizing stagger times can assist with achieving signal and timing margins, latency times, and reduce power delivery noise on a particular board and package type.

By adjusting the lane-to-lane and port-to-port staggering, the power delivery noise can reduce and consequently, the lane margining (e.g., signal eye height and width) at receiver can improve. Stagger values can be changed for L0, L1, and L0p per lane and per port based on characterization of lane margins and power supply noise characterizations during these transitions.

In some examples, system 100 can be implemented as part of a system-on-a-chip (SoC) or system in package (SiP). Various examples of system 100 can be implemented as a discrete device, in a die, in a chip, on a die or chip mounted to a circuit board, in a package, or between multiple packages, in a server, in a CPU socket, or among multiple servers.

FIG. 1B depicts an example system that can determine a number of ports that are changing power states and adjust a lane-to-lane offset based on the number of ports that are changing power states. At boot time, firmware 160 can load initial lane-to-lane stagger values for port 0 to N, where N is an integer, into respective stagger delay registers, described herein. Ports 0 to N can signal an exit or entrance into reduce power state to aggregator 170. For a window of time, aggregator 170 can sum a number of ports that indicate a change in power states. Based on a number of ports changing power states, aggregator 170 can adjust an amount of configured lane-to-lane stagger. For example, if only port 0 is changing power states, aggregator 170 can reduce stagger value by a StaggerChange signal to a lower permitted level, as stagger between ports may not be needed to reduce noise margin. For example, a lower permitted stagger level can be 24 ns or other values.

For example, if multiple ports (e.g., ports 0 and 2) are changing power states, aggregator 170 can reduce stagger value by a StaggerChange signal to a second permitted level, that is higher than the lower permitted stagger level, as less stagger between ports may be needed to reduce noise margin.

For example, if a number of ports (e.g., 4 or other number) are changing power states, aggregator 170 may not stagger values, as stagger between ports may be needed to reduce noise margin.

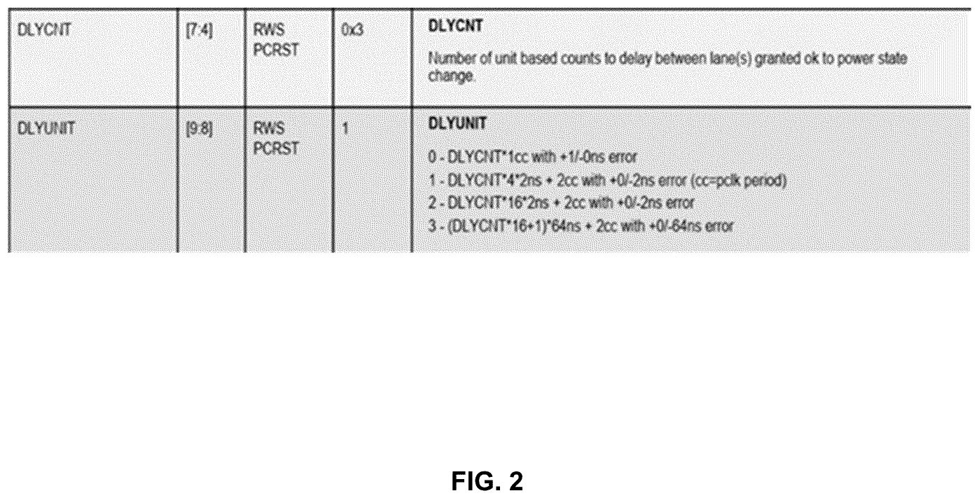

FIG. 2 depicts examples of manners of calculating delay or stagger values. In some examples, per-lane delay values can be stored in registers as offset values 144. In some examples, per-lane delay count (DLYCNT) and delay unit (DLYUNIT) values can be calculated based on values stored in the registers. As an example, if DLYCNT=3 and DLYUNIT=1, the stagger time to transition from L0p or L1 to L0 can be equal to 26 ns (3*4*2 ns+2=26 ns). If DLYCNT=10 and DLYUNIT=2, stagger time can be equal to 322 ns (10*16*2+2=322 ns).

Table 1 depicts examples of stagger times for various examples of delay count and delay unit.

TABLE 1

| DelayCount | Delay_unit = 0 | Delay_unit = 1 | Delay_unit = 2 | Delay_Unit = 3 |
|---|---|---|---|---|
| 0 | 0 | 2 | 2 | 66 |
| 1 | 1 | 10 | 34 | 1090 |
| 2 | 2 | 18 | 66 | 2114 |
| 3 | 3 | 26 | 98 | 3138 |
| 4 | 4 | 34 | 130 | 4162 |
| 5 | 5 | 42 | 162 | 5186 |
| 6 | 6 | 50 | 194 | 6210 |
| 7 | 7 | 58 | 226 | 7234 |
| 8 | 8 | 66 | 258 | 8258 |
| 9 | 9 | 74 | 290 | 9282 |
| 10 | 10 | 82 | 322 | 10306 |
| 11 | 11 | 90 | 354 | 11330 |
| 12 | 12 | 98 | 386 | 12354 |
| 13 | 13 | 106 | 418 | 13378 |
| 14 | 14 | 114 | 450 | 14402 |
| 15 | 15 | 122 | 482 | 15426 |

Table 2 depicts an example of port-to-port stagger values. For example, for ports 0-2, distinct lane-to-lane stagger values for lanes can be programmed of respective 290 ns, 322 ns and 354 ns. The stagger time spread between each lane exit across the ports increases as active lane count increases. Exits of lanes of Port0, Port1, and Port3 to active power state or from active power state to one of multiple lower power states can be staggered. Accordingly, lanes from a port may not enter active power simultaneously, thereby reducing a noise signature on the power supply. A port-to-port time difference at power state exit for lane #1 (L1 in Table 2) is 32 ns while port-to-port time difference at power state exit for lane #15 (L15 in Table 2) is 480 ns. A port-to-port time difference at power state exit for lanel is 32 ns while port-to-port time difference at power state exit for Lane15 is 480 ns.

TABLE 2

| | L0 | L1 | L2 | L3 | . . . | L11 | L12 | L13 | L14 | L15 |
|---|---|---|---|---|---|---|---|---|---|---|
| PORT0 | 0 | 290 | 580 | 870 | . . . | 11 | 12 | 13 | 14 | 15 |
| PORT1 | 0 | 322 | 644 | 966 | . . . | 3190 | 3480 | 3770 | 4060 | 4350 |
| PORT2 | 0 | 354 | 708 | 1062 | . . . | 3542 | 3864 | 4186 | 4508 | 4830 |
| | | | | | . . . | 3894 | 4248 | 4602 | 4956 | 5310 |
| PORT0-PORT1 | 0 | 32 | 64 | 96 | . . . | 352 | 384 | 416 | 448 | 480 |
| PORT0-PORT2 | 0 | 64 | 128 | 192 | . . . | 704 | 768 | 832 | 896 | 960 |

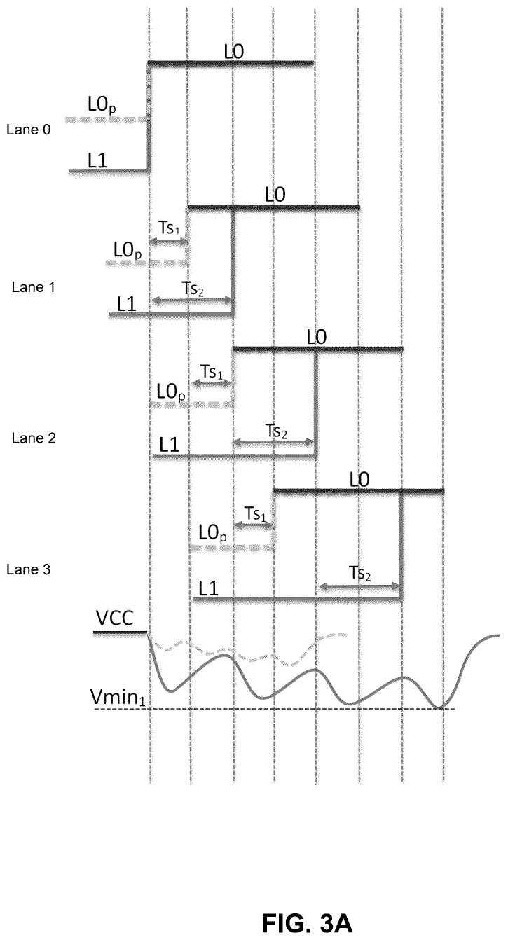

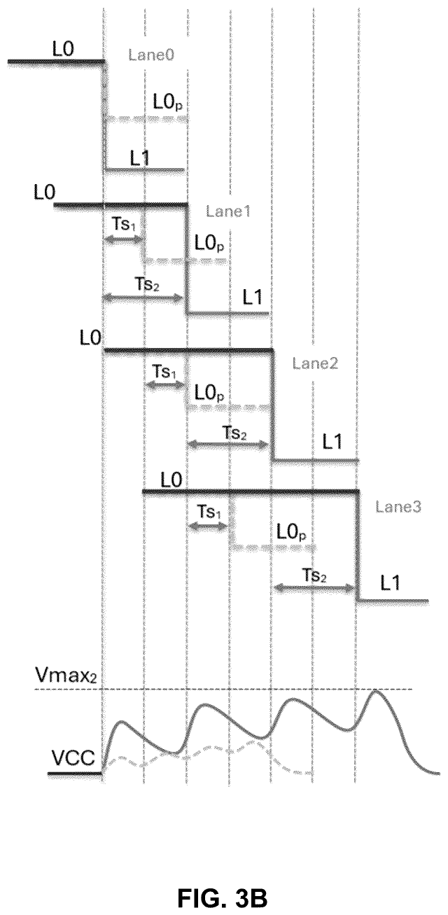

FIG. 3A depicts an example of utilization of distinct stagger values, Ts₁ and Ts₂, for L0p and L1 to L0 respectively. For example, for port P0, between lane #0 and lane #1, Ts₁ indicates a transition delay from L0p to L0 where Ts₂ indicates a transition delay from L1 to L0. Likewise, between lane #1 and lane #2, Ts₁ indicates a transition delay from L0p to L0 where Ts₂ indicates a transition delay from L1 to L0.

FIG. 3B depicts an example of utilization of distinct stagger values, Ts₁ and Ts₂, for L0 to L0p and L1, respectively. For example, for port P0, between lane #0 and lane #1, Ts₁ indicates a transition delay from L0 to L0p whereas Ts₂ indicates a transition delay from L0 to L1. Likewise, between lane #1 and lane #2, Ts₁ indicates a transition delay from L0 to L0p where Ts₂ indicates a transition delay from L0 to L1.

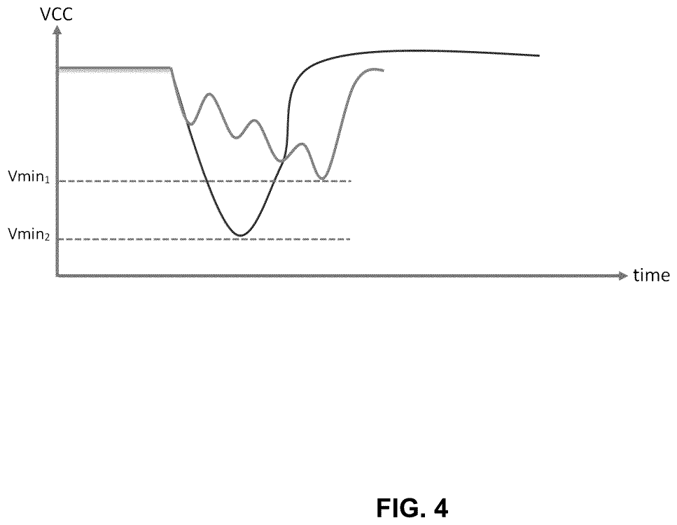

FIG. 4 shows an example power delivery noise improvement using L1 and L0p stagger feature. Power delivery noise can improve where Vmin2 (without stagger)<Vmin1 (with staggering). A higher Vmin may be preferred as it provides a relatively smaller deviation from nominal silicon voltage during a transient event. Lower noise can support counts of increased lanes or ports, reduce the constraints and cost of the power delivery network, improve robustness due to improved margins, and reduce cost of platforms that are limited by form factors with smaller sockets and lighter packages.

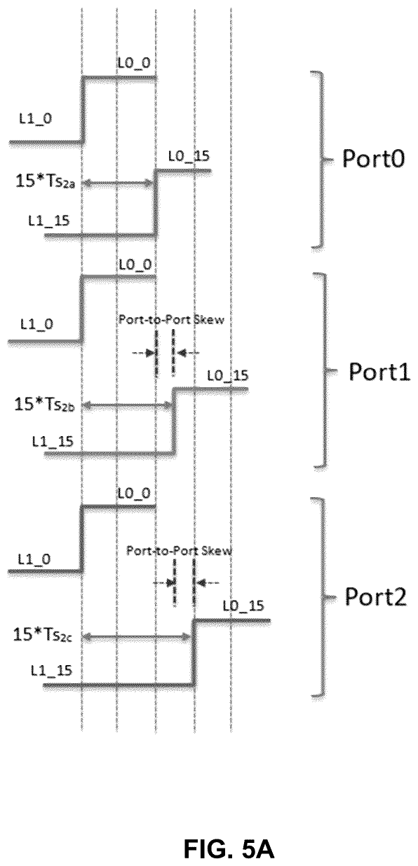

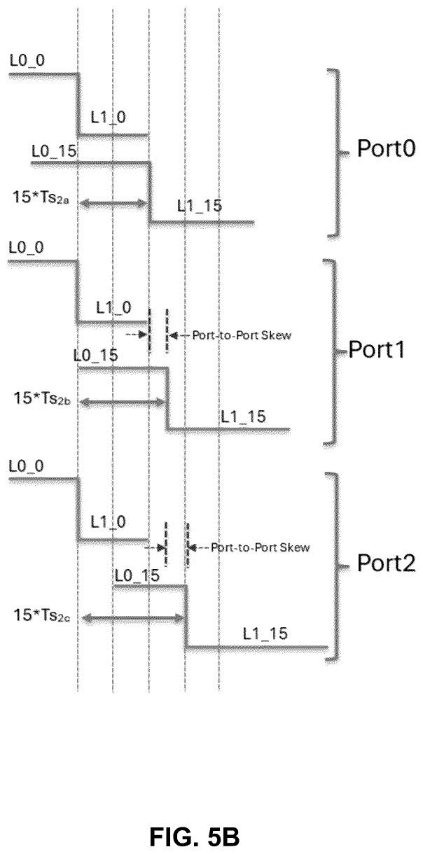

FIG. 5A depicts an example of configured timing delay between transitions from one of multiple reduced power states to an active power state from port-to-port. Stagger for transition from L1 to L0 between lanes of port 0-2 can be respective Ts₂ₐ, Ts_{2b} and Ts_{2c}. For 16 lanes in port 0 to 2, stagger for transition from L1 to L0 between lanes 0 and 15 can be respective 15*Ts₂ₐ, 15*Ts_{2b}, and 15*Ts_{2c}. For a same lane number of different ports, port-to-port skew for transitions from L1 to L0 can be achieved. For example, lane 15 of port 0 and lane 15 of port 1 can achieve skew, as can lane 15 of port 1 and lane 15 of port 2. Although not depicted, port-to-port skew for transitions from L0p to L0 can be achieved by using of configured timing delay.

FIG. 5B depicts an example of configured timing delay between transitions from an active power state to a lower power state from port-to-port. Stagger for transition from L0 to L1 between lanes of port 0-2 can be respective Ts₂ₐ, Ts_{2b} and Ts_{2c}. For 16 lanes in port 0 to 2, stagger for transition from L0 to L1 between lanes 0 and 15 can be respective 15*Ts₂ₐ, 15*Ts_{2b}, and 15*Ts_{2c}. For a same lane number of different ports, port-to-port skew for transitions from L0 to L1 can be achieved. For example, lane 15 of port 0 and lane 15 of port 1 can achieve skew as can lane 15 of port 1 and lane 15 of port 2. Although not depicted, port-to-port skew for transitions from L0p to L1 can be achieved by using of configured timing delay.

Table 3 shows an improvement of power supply noise when lane-to-lane only and lane-to-lane combined with port-to-port stagger are utilized compared to non-utilization of lane-to-lane stagger.

TABLE 3

| | | | | Other |
|---|---|---|---|---|
| | | Pk-to-Pk | Pk-to-Pk | Board/Pkg |
| | Vmin/Vmax | (100 kHz-10 Mhz) | (10 Mhz-100 Mhz) | level gains |
| Non-use of staggering | −4%/+5% | 2.8% | 3.97% | |
| Lane-to-Lane Stagger | Gain of 15%/ | Gain of 43% | ~Same | ~40% reduction |
| Added | 20% | | | in caps and area |
| Lane-to-Lane | Gain of 15%/ | Gain of 43% | Improvement | |
| combined with Port- | 20% | | of 25% | |
| to-Port Stagger Added | | | | |

FIG. 6 depicts an example process. At 602, lane-to-lane stagger can be configured for a first reduced power state to an active state and for a second reduced power state to the active state. In addition, lane-to-lane stagger can be configured for the active state to the first reduced power state and for the second reduced power state to the active state. In some examples, the first reduced power state can be PCIe L0p. In some examples, the second reduced power state can be PCIe L1. In some examples, the active power state can be PCIe L0. For example, a value in the register bits DelayCount and Delay_unit can specify the lane-to-lane stagger. In some examples, lane-to-lane stagger can be consistent. In some examples, lane-to-lane stagger can be different values. Lane-to-lane stagger also provide port-to-port stagger.

At 604, during operation of a port, lane-to-lane stagger for transition of power states can be applied.

At 606, lane-to-lane stagger can be adjusted based on Vmin/Vmax violations or lower margin than expected and the adjusted lane-to-lane stagger can be applied to transitions of lower power states to an active power state or vice versa. Revised lane-to-lane stagger can be adjusted at power-on or dynamically during use of a lane.

FIG. 7 depicts a system. The system can use examples to set lane-to-lane and port-to-port timing offset of changes from lower power states to active power state or vice versa for communication between devices using lanes of ports, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die.

Accelerators 742 can be a fixed function or programmable offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as static random-access memory (SRAM), dynamic random-access memory (DRAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. In some examples, network interface 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 750 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDAR, NVIDIA® DOCA™ Data Plane Development Kit (DPDK), OpenDataPlane (ODP), Infrastructure Programmer Development Kit (IPDK), x86 compatible executable binaries or other executable binaries, or others.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: an interface and first circuitry to, based on a configuration: for a power state transition, apply one of multiple sets of lane-to-lane stagger times associated with different respective power state transitions.

Example 2 includes one or more later or earlier examples, wherein the configuration is to set port-to-port stagger times between multiple power saving states and an active power state.

Example 3 includes one or more later or earlier examples and includes second circuitry to, based on the configuration, apply lane-to-lane stagger times for a second port between multiple power saving states and an active power state.

Example 4 includes one or more later or earlier examples, wherein: a first power state of the power state transitions comprises a Peripheral Component Interconnect express (PCIe) L0p state and a second power state of the power state transitions comprises a PCIe L1 state.

Example 5 includes one or more later or earlier examples, wherein: an active power state of the power state transitions comprises a Peripheral Component Interconnect express (PCIe) L0 state.

Example 6 includes one or more later or earlier examples, wherein: the first circuitry is to, based on the configuration, apply lane-to-lane stagger times for a first port between an active power state and multiple power saving states.

Example 7 includes one or more later or earlier examples, and includes a processor-executed firmware to set the configuration.

Example 8 includes one or more later or earlier examples, and includes at least one non-transitory computer-readable medium, comprising instructions stored thereon, that if executed by one or more processors, cause the one or more processors to: configure first circuitry to apply one of multiple lane-to-lane stagger times for a first port between multiple power saving states and an active power state and port-to-port stagger times between the multiple power saving states and the active power state.

Example 9 includes one or more later or earlier examples, and includes instructions stored thereon, that if executed by one or more processors, cause the one or more processors to: configure second circuitry to apply one of multiple lane-to-lane stagger times for a second port between the multiple power saving states and the active power state.

Example 10 includes one or more later or earlier examples, comprising instructions stored thereon, that if executed by one or more processors, cause the one or more processors to: configure the first circuitry is to, based on the configuration, apply lane-to-lane stagger times for the first port between the multiple power saving states and the active power state.

Example 11 includes one or more later or earlier examples, wherein: a first power state of the multiple power saving states comprises a Peripheral Component Interconnect express (PCIe) L0p state and a second power state of the multiple power saving states comprises a PCIe L1 state.

Example 12 includes one or more later or earlier examples, wherein: the active power state comprises a Peripheral Component Interconnect express (PCIe) L0 state.

Example 13 includes one or more later or earlier examples, wherein the instructions are associated with a firmware.

Example 14 includes one or more later or earlier examples, and includes a method that includes: applying one of multiple lane-to-lane stagger times for a first port for between multiple power saving states and an active power state and applying one of multiple lane-to-lane stagger times for a second port for between multiple power saving states and an active power state.

Example 15 includes one or more later or earlier examples, wherein: a first power state of the multiple power saving states comprises a Peripheral Component Interconnect express (PCIe) L0p state.

Example 16 includes one or more later or earlier examples, wherein: a second power state of the multiple power saving states comprises a PCIe L1 state.

Example 17 includes one or more later or earlier examples, wherein: the active power state comprises a Peripheral Component Interconnect express (PCIe) L0 state.

Example 18 includes one or more later or earlier examples, and includes applying timing offsets between the multiple power saving states and the active power state for the first and second ports.

Example 19 includes one or earlier examples, and includes applying lane-to-lane stagger times for the first port between the active power state and multiple power saving states.

1. An apparatus comprising:
an interface and
first circuitry to, based on a configuration:
for a power state transition, apply one of multiple sets of lane-to-lane stagger times associated with different respective power state transitions.

2. The apparatus of claim 1, wherein the configuration is to set port-to-port stagger times between multiple power saving states and an active power state.

3. The apparatus of claim 1, comprising:
second circuitry to, based on the configuration, apply lane-to-lane stagger times for a second port between multiple power saving states and an active power state.

4. The apparatus of claim 1, wherein:
a first power state of the power state transitions comprises a Peripheral Component Interconnect express (PCIe) L0p state and
a second power state of the power state transitions comprises a PCIe L1 state.

5. The apparatus of claim 1, wherein:
an active power state of the power state transitions comprises a Peripheral Component Interconnect express (PCIe) L0 state.

6. The apparatus of claim 1, wherein:
the first circuitry is to, based on the configuration, apply lane-to-lane stagger times for a first port between an active power state and multiple power saving states.

7. The apparatus of claim 1, comprising:
a processor-executed firmware to set the configuration.

8. At least one non-transitory computer-readable medium, comprising instructions stored thereon, that if executed by one or more processors, cause the one or more processors to:
configure first circuitry to apply one of multiple lane-to-lane stagger times for a first port between multiple power saving states and an active power state and port-to-port stagger times between the multiple power saving states and the active power state.

9. The non-transitory computer-readable medium of claim 8, comprising instructions stored thereon, that if executed by one or more processors, cause the one or more processors to:
configure second circuitry to apply one of multiple lane-to-lane stagger times for a second port between the multiple power saving states and the active power state.

10. The non-transitory computer-readable medium of claim 8, comprising instructions stored thereon, that if executed by one or more processors, cause the one or more processors to:
configure the first circuitry is to, based on the configuration, apply lane-to-lane stagger times for the first port between the multiple power saving states and the active power state.

11. The non-transitory computer-readable medium of claim 8, wherein:
a first power state of the multiple power saving states comprises a Peripheral Component Interconnect express (PCIe) L0p state and
a second power state of the multiple power saving states comprises a PCIe L1 state.

12. The non-transitory computer-readable medium of claim 8, wherein:
the active power state comprises a Peripheral Component Interconnect express (PCIe) L0 state.

13. The non-transitory computer-readable medium of claim 8, wherein the instructions are associated with a firmware.

14. A method comprising:
applying one of multiple lane-to-lane stagger times for a first port for between multiple power saving states and an active power state and
applying one of multiple lane-to-lane stagger times for a second port for between multiple power saving states and an active power state.

15. The method of claim 14, wherein:
a first power state of the multiple power saving states comprises a Peripheral Component Interconnect express (PCIe) L0p state.

16. The method of claim 14, wherein:
a second power state of the multiple power saving states comprises a PCIe L1 state.

17. The method of claim 16, wherein:
the active power state comprises a Peripheral Component Interconnect express (PCIe) L0 state.

18. The method of claim 14, comprising:
applying timing offsets between the multiple power saving states and the active power state for the first and second ports.

19. The method of claim 14, comprising:
applying lane-to-lane stagger times for the first port between the active power state and multiple power saving states.
